(19) United States
(12) Patent Application Publication
(10) Pub. No.: US 2007/0040816 A1
(43) Pub. Date: Feb. 22, 2007

(54) Display apparatus, electronics device equipped with display apparatus, and manufacturing method thereof

(75) Inventor: Naohito Toyomaki, Kanagawa (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NEC LCD TECHNOLOGIES, LTD., Kawasaki (JP)

(21) Appl. No.: 11/501,119

(22) Filed: Aug. 9, 2006

(30) Foreign Application Priority Data
Aug. 17, 2005 (JP) 236531/2005

(51) Int. Cl. G09G 5/00

(52) U.S. Cl. 345/174

(57) ABSTRACT

A display apparatus includes a display panel displaying an image thereon, a cover panel arranged facing the display panel across an air layer, and an electro-conductive material opening electrically and arranged on a surface of one of the display panel and the cover panel faced with the air layer.

### BACKGROUND OF THE INVENTION

1. Field of the Invention

The present invention relates to a display apparatus, an electronic device equipped with the display apparatus, and a manufacturing method thereof. In particular, the present invention relates to a display apparatus equipped with a cover panel, an electronic device equipped with the display apparatus, and a manufacturing method thereof.

2. Description of the Related Art

In most of display apparatuses for displaying an image, the display plane side of a display panel is covered with a cover panel for protection from foreign materials or water, enhancement of optical characteristics, and the like. In the display apparatuses, there is a touch panel type display apparatus equipped with a cover panel having a function of detecting a pressed position. The display apparatuses equipped with such a touch panel have been popularized in the forms of personal digital assistants (PDAs), and so-called “Smartphone”, namely, multi-functionalized recent portable telephones. The major uses of the above-explained display apparatuses equipped with the touch panel are as the inputting and the outputting of data, the viewing of electronic mails or Web sites, and the like. However, as a matter of course, these PDAs and “Smartphones” should be necessarily made compact and lightweight. Also, in the case where these PDAs and “Smartphones” have telephone functions, it is preferable that there is no noise during a telephone conversation.

As an example, FIG. 8 shows a structural example of a liquid crystal display apparatus equipped with a touch panel, which relates to a technique of the present invention. As indicated in FIG. 8, the liquid crystal display apparatus 210 of the related art is equipped with a liquid crystal panel 110, a touch panel 120, and a chassis frame 130. The liquid crystal panel 110 is equipped with a thin-film transistor (TFT) substrate 111, a color filter substrate 112, and also polarizing films 113 and 114. The touch panel 120 is arranged over a display plane side of the liquid crystal panel 110 to oppose the liquid crystal panel 110 across an air layer 140. The touch panel 120 is equipped with an upper substrate 121 and a lower substrate 122. The chassis frame 130 supports both the liquid crystal panel 110 and the touch panel 120 by spacing the air layer 140. It should be noted that these panels are fixed to the chassis frame 130 by using two-sided adhesive compounds 125, 131, and 132. It should also be understood that the touch panel 120 also functions as a cover panel.

In this liquid crystal display apparatus 210 with the touch panel 120 mounted thereon, as represented in FIG. 9, a common electrode signal is applied to the liquid crystal panel 110 in order to drive the liquid crystal panel 110. However, very small vibrations are generated in the liquid crystal panel 110 as a secondary effect due to an inverse piezoelectric effect by static electricity. The generated vibrations are propagated through the air layer 140, and further, make the touch panel 120 arranged on the upper portion of the air layer 140 vibrate although being minute.

When an input action and a pressure load are given to the touch panel 120 under this condition, the touch panel 120 comes in contact with the liquid crystal panel 110 in the air layer 140, and thereafter, the touch panel 120 comes off the liquid crystal panel 110. Then, static electricity is produced on the contacted/peeled part, and as shown in FIG. 10, electric charges are produced. However, since the plane of the liquid crystal panel 110 and the plane of the touch panel 120 on sides of the air layer 140 are formed of insulators, the electric charges are not discharged, and these planes are left under a condition that accumulates the electric charges. As a result, electrostatic force is produced in the air layer 140 corresponding to a direction of an electric field produced by the common electrode signal. As a consequence, vibrations are generated in synchronization with the amplitude of the common electrode signal. Similarly, the vibrations are overlapped additionally with the very small vibrations caused by the above-explained inverse piezoelectric effect, and generated due to the influence made by the common electrode signal, so that the vibrations are amplified.

FIG. 11 is a graph for representing a relationship between a contact number and a charged amount as to the liquid crystal panel 110 and the touch panel 120. As understood from this graph, the charged amount depends upon the contact number. Also, there is a difference in increase in charged amounts between a stylus pen whose tip portion is relatively sharp, and a finger whose tip portion is relatively flat. As apparent from this fact, the charged amounts also depend upon the contact areas. Generation of the vibrations caused by the charging depends upon a frequency of a common electrode signal. In the case where this frequency is present in an audio frequency range, vibrations generated by this frequency may be heard as sound, or noise. As a result of experiments executed by the inventor of the prevent invention, the inventor could recognize that when sound levels were measured by employing a sound level meter, measurement values in the range of 10 KHz of the measuring device were correlative to audible levels. Also, while various sorts of noise are produced from liquid crystal display apparatus, it was found that the sound is recognizable by bringing human ears close to the display apparatus when the sound level is approximately 15 dB or higher.

FIG. 12 is a graph for indicating a relationship between charged amounts and sound levels in a liquid crystal display apparatus, which were measured by the above-explained measuring method. As understood from this graph, the charged amount and the sound level have a substantially direct proportional relationship. Accordingly, it can be understood that the larger the charged amount becomes, the higher the sound level becomes.

As a consequence, in order to prevent this generation of sound, it is required that the electric charge itself is not generated, or the charged amount is not increased to such a sound level that the vibrations caused by the charged amount may be heard as the sound. To this end, the following method may be conceived. That is, the thickness of the air layer 140 is increased in such a manner that even when the liquid crystal panel 110 and the touch panel 120 receive such pressure loads as input actions, these liquid crystal panel 110 and touch panel 120 are not easily contacted to each other. However, in order to suppress the charged amounts to an inaudible sound level, the thickness of the air layer 140 must be made sufficiently thick. As a result, there is a problem that the entire thickness of the liquid crystal display apparatus 210 is increased.

On the other hand, another method may be conceived. That is, the structural components of the liquid crystal display apparatus 210 are made in solid shapes in such a manner that even when the liquid crystal panel 110 and the touch panel 120 receive the above-explained pressure loads, the touch panel 120 is not contacted with the liquid crystal panel 110. However, in this case, the thicknesses of the structural components must be made thick. As a result, similar to the above-explained case, there is another problem that the entire thickness of the liquid crystal display apparatus 210 is increased.

As another proposed idea, for example, there is a related art document of a liquid crystal display apparatus (refer to Japanese Patent Laid-Open No. 2002-341372, pages 3 to 5, FIG. 1). This liquid crystal apparatus installs a transparent conductive membrane on the side of a display plane of a liquid crystal panel, and earth means electrically connects this transparent conductive membrane to the ground. As a result, the liquid crystal panel may be electromagnetically shielded. A touch panel is arranged on an outer surface of this transparent conductive membrane.

However, in this structure, since the transparent conductive membrane is electrically connected to the ground, a potential difference is produced between the touch panel and the liquid crystal panel. As a result, there are some possibilities that vibrations that have occurred between the liquid crystal panel and the touch panel are amplified. Actually, when the experiment was carried out in the liquid crystal display apparatus having this structure, the effect of suppressing the sound was not be observed, but rather the sound was increased. As previously explained, although this structure can prevent the electromagnetic waves which are inputted/outputted via the display screen, there is such a problem that the sound cannot be suppressed.

### SUMMARY OF THE INVENTION

In view of the above-mentioned and other exemplary problems, drawbacks and disadvantages of the related art methods and structures, an exemplary feature of the present invention is to provide a display apparatus, an electronic device equipped with the display apparatus, and a manufacturing method thereof capable of suppressing an electric charge generated by repetition of contact and separation between a display panel and a touch panel.

A display apparatus according to the present invention includes a display panel displaying an image thereon, a cover panel arranged facing the display panel across an air layer, and an electro-conductive material opening electrically and arranged on a surface of one of the display panel and the cover panel faced with the air layer.

A method of manufacturing a display apparatus according to the present invention including a display panel for displaying an image thereon, the method includes forming a nonionic-based surface active agent in a mist form, causing the nonionic-based surface active agent to be adsorbed on a surface of the display panel, and forming an electrically opened electro-conductive material on the surface of the display panel.

Since the above-described structure is employed, the display apparatus, the electronic device equipped with the display apparatus, and the manufacturing method thereof, according to the present invention, have the following effects. That is, when the touch panel comes in contact with the display panel and then comes off the display panel by the input action or the pressure load given to the touch panel, it is possible to suppress the electric charges generated by static electricity to be charged to the peeled part.

### BRIEF DESCRIPTION OF THE DRAWINGS

The exemplary aspects, features and advantages of the present invention will become more apparent from the following detailed description when taken in conjunction with the accompanying drawings wherein:

FIG. 1 is a side view for schematically indicating a structure of a liquid crystal display apparatus equipped with a touch panel, according to Exemplary Aspect 1 of the present invention;

FIG. 2 is a side view for indicating a schematic arrangement of a processing apparatus which is employed for manufacturing a liquid crystal display apparatus equipped with a touch panel, according to the present invention;

FIG. 3 is a graph for representing a relationship between a contact number and a charged amount between the liquid crystal panel and the touch panel;

FIG. 4 is a graph for indicating a relationship between a contact number and a sound level between the liquid crystal panel and the touch panel;

FIG. 5 is a side view for schematically indicating a structure of a liquid crystal display apparatus equipped with a touch panel, according to Exemplary Aspect 2 of the present invention;

FIG. 6 is a side view for schematically showing a modification of Exemplary Aspect 2 of the present invention;

FIG. 7 is a side view for schematically indicating a structure of a liquid crystal display apparatus equipped with a touch panel, according to Exemplary Aspect 3 of the present invention;

FIG. 8 is a side view for schematically showing a structure of a liquid crystal display apparatus related to a present technical idea;

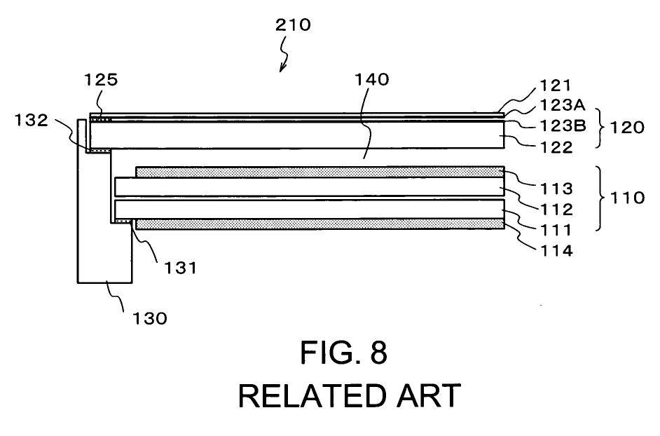

FIG. 9 is a side view for schematically indicating such a condition that a common electrode signal is applied to the liquid crystal display apparatus related to the present technical idea;

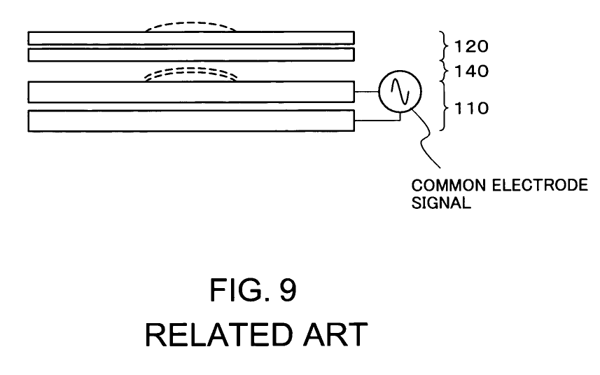

FIG. 10 is a side view for schematically showing such a condition that a sound is produced by the liquid crystal display device related to the present technical idea;

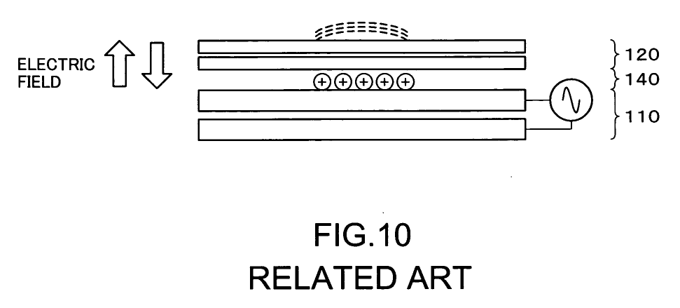

FIG. 11 is a graph for representing the relationship between the contact number and the charged amount between the liquid crystal panel and the touch panel, related to the present technical idea; and

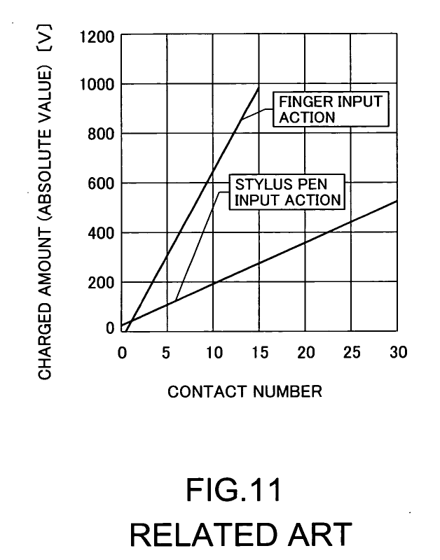

FIG. 12 is a graph for indicating the relationship between the contact number and the sound level of the liquid crystal display apparatus related to the present technical idea.

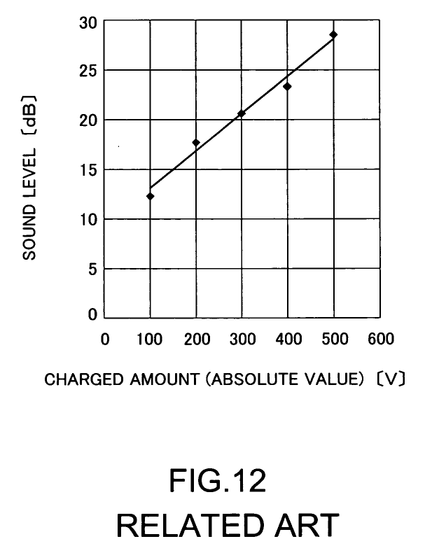

### DETAILED DESCRIPTION OF THE PREFERRED ASPECTS

Exemplary aspects for carrying out the present invention will be described in detail below with reference to the drawing. The exemplary aspects described below show only illustrative examples in understanding the present invention, and the claims of the invention are not limited to these exemplary aspects.

Referring now to drawings, a detailed description is made of a liquid crystal display apparatus equipped with a touch panel, and a manufacturing method thereof, according to Exemplary Aspect 1 of the present invention.

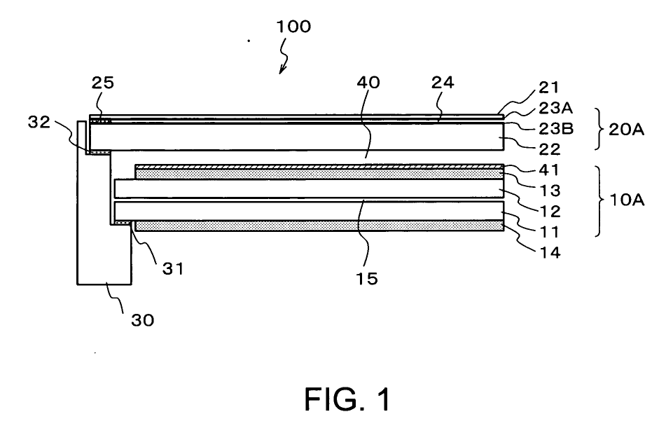

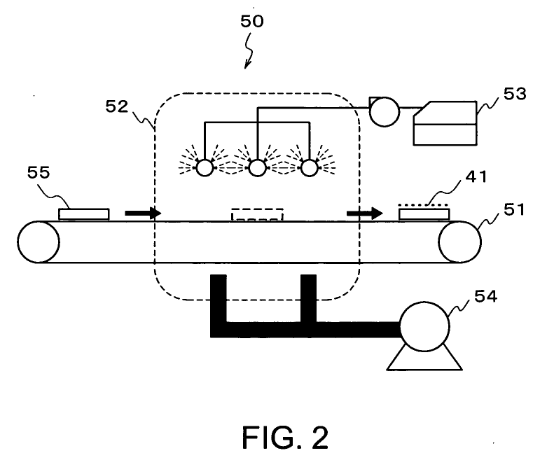

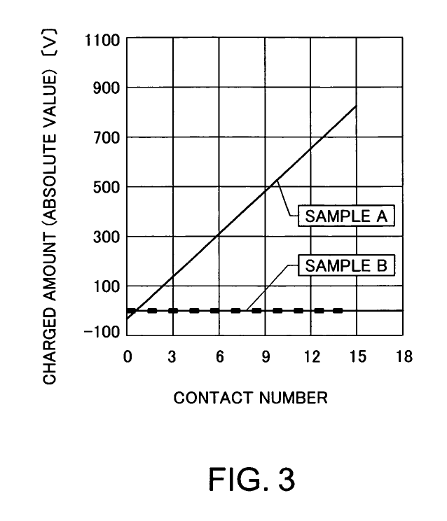

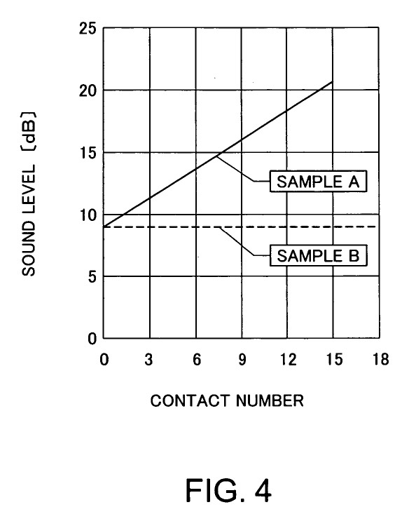

FIG. 1 is a side view for schematically indicating a structure of a liquid crystal display apparatus equipped with the touch panel, according to Exemplary Aspect 1 of the present invention. FIG. 2 is a side view for indicating a schematic arrangement of a processing apparatus which is employed for manufacturing the liquid crystal display apparatus equipped with touch panel, according to the present invention. FIG. 3 is a graph for representing a relationship between a contact number and a charged amount between the liquid crystal panel and the touch panel. FIG. 4 is a graph for indicating a relationship between a contact number and a sound level between the liquid crystal panel and the touch panel.

As indicated in FIG. 1, a liquid crystal display apparatus 100 of Exemplary Aspect 1 includes a liquid crystal panel 10A, a touch panel 20A, and a chassis frame 30 which holds the liquid crystal panel 10A and the touch panel 20A.

The liquid crystal panel 10A is arranged by an active matrix substrate (also called a thin-film transistor substrate, and hereinafter referred to as TFT substrate) 11 and a color filter substrate 12 which sandwich a liquid crystal layer 15. Furthermore, a polarizing film 14 is mounted on the TFT substrate 11, and a polarizing film 13 is mounted on the color filter substrate 12. It should be understood that a switching element (not shown) such as a TFT (Thin-Film Transistor) for driving liquid crystal is arranged on the TFT substrate 11. Also, an electrode layer (not shown) located opposite to the color filter substrate 11 is formed on this color filter substrate 12.

In the touch panel 20A, for example, a resistive-film system is employed. In this touch panel 20A, an upper substrate 21 and a lower substrate 22 are arranged in such a manner that the upper substrate 21 and the lower substrate 22 are located opposite to each with an air layer 24 sandwiched between them. A transparent conductive membrane 23A functioning as a position sensitive electrode is formed on a surface of the upper substrate 21. Similarly, another transparent conductive membrane 23B functioning as a position sensitive electrode is formed on a surface of the lower substrate 22. Then, the upper substrate 21 and the lower substrate 22 are arranged in such a manner that the transparent conductive membranes 23A and 23B are located opposite to each other. The upper substrate 21 and the lower substrate 22 are held with a predetermined gap maintained between these substrates 21 and 22 by way of a two-sided adhesive compound 25 provided on peripheral portions thereof. This two-sided adhesive compound 25 also functions as a spacer.

The chassis frame 30 has a spacer function, and stepped portions for determining fixed positions as to the liquid crystal panel 10A and the touch panel 20A are provided on this chassis frame 30. Therefore, an air layer 40 is formed between the liquid crystal panel 10A and the touch panel 20A. The liquid crystal panel 10A and the touch panel 20A are fixed at the predetermined positions of the chassis frame 30 by two-sided adhesive compounds 31 and 32 respectively.

This air layer 40 is made to have such a dimension that the touch panel 20A and the liquid crystal panel 10A are not easily contacted to each other due to cambers of the touch panel 20A or weight (for example, 300 to 500 gf (gram-force)) on the touch panel 20A by input action performed by an input pen or a finger. The thickness of the air layer 40 is, for example, 0.15 mm to 0.3 mm.

However, in the case where the cambers of the touch panel 20A or the input weight are increased, the lower substrate 22 of the touch panel 20A may come in contact with the upper polarizing film 12 of the liquid crystal panel 1A. Then, these touch panel 20A and liquid crystal panel 10A come off each other due to inertia. In particular, in such a case where the camber of the touch panel 20A is large, and the input weight is heavy, this phenomenon frequently occurs. At this time, electric charges are charged due to static electricity produced by the peeling effect at the contact portion of the surface of the upper polarizing film 13. This effect may constitute the above-explained reason why the vibrations are generated. Accordingly, in Exemplary Aspect 1, in order to prevent this charging operation, an antistatic membrane 41 is formed on the surface of the upper polarizing film 13. This antistatic membrane 41 has been brought into an electrically open status. In other words, this antistatic membrane 41 has been set to an electrically floating status, and is not electrically energized. This antistatic membrane 41 diffuses the electric charges produced when the touch panel 20A and the liquid crystal panel 10 come off each other so as to avoid an increase of the electrostatic force.

It should be understood that the above-described antistatic membrane 41 may be provided with a function capable of preventing charging operation. More preferably, it is desirable that a surface resistance value of the antistatic membrane 41 is equal to or lower than an approximately 1×E12 Ω/square. As a result, the concentrative charging operations can be more effectively prevented. Also, it is preferable that the antistatic membrane 41 may be made of a colorless and transparent membrane, and a visible light transmittance thereof is equal to or higher than approximately 95%. Therefore, it is possible to avoid that a display is disturbed. Also, a thickness of the antistatic membrane 41 may be made equal to or smaller than approximately 1 μm. As to the antistatic membrane 41, a nonionic surface active agent is employed as a major component, and more specifically, a fluorine element-based may be employed. The surface active agent owns a nature capable of charging and activating a surface of an insulating material which can be easily charged.

Next, a description is made of an assembling step as to the liquid crystal display apparatus 100 with the touch panel 20A mounted thereon, according to Exemplary Aspect 1. In particular, a method for forming the antistatic membrane 41 on the surface of the liquid crystal panel 10A will now be explained.

In FIG. 1, the TFT substrate 11 is overlapped with the color filter substrate 12, and the polarizing films 13 and 14 are mounted on the liquid crystal panel 10A into which the liquid crystal 15 has been injected. Next, a flexible substrate (not shown) through which a drive voltage, an input signal, and the like are transferred from a circuit, is mounted by a pressure contacting method or the like. Also, a driver integrated circuit (referred to as IC; not shown) for driving the liquid crystal panel 10A is mounted by a pressure contacting method or the like. It should also be noted that this driver IC may be alternatively assembled in the liquid crystal panel 10A. Moreover, in the case of either a transmissive type liquid crystal display apparatus or a semitransmissive type liquid crystal display apparatus, a back light (not shown) is mounted. Under this condition, the liquid crystal display apparatus 100 is under a semi-finished condition that the remaining touch panel 20A is merely mounted thereon.

In this status, the antistatic membrane 41 is formed on a surface of the liquid crystal panel 10A. For instance, a processing apparatus is prepared by which a process fluid is made in a mist form and then the mist-formed process fluid can be filled in a chamber. It should also be understood that the process fluid may be preferably a composite water solution by employing a nonionic surface active agent, and the processing apparatus may preferably form mists, the averaged diameter of which is equal to or smaller than 20 μm.

FIG. 2 is a side view for showing a schematic structure of a processing apparatus 50 employed so as to manufacture a liquid crystal display apparatus with a touch panel mounted thereon according to the present invention. The processing apparatus 50 is equipped with a transporting means 51 capable of transporting the liquid crystal display apparatus 55 which has been brought into the semi-finished condition described above at a constant speed. The liquid crystal display apparatus 55 under the semi-finished condition is transported at the constant speed within a chamber 52 into which the mists have been filled. As a result, a thin membrane over which a process fluid has been sprayed is formed on a surface of the liquid crystal display apparatus, namely, a surface of the upper polarizing film 13 which has passed through the chamber 52. This membrane is made of such a thin film having a thickness equal to or thinner than 1 μm. Also, since the process fluid itself is colorless and transparent, the membrane which has been uniformly sprayed in the mist form is also colorless and transparent. A visible light transmittance of the membrane is maintained equal to or higher than 95%.

To be more specific, as a surface active agent of the process fluid, a fluorine-based surface active agent thereof may be employed. The processing apparatus 50 may preferably spray a process fluid of 10 to 50 ml/min in the mist form. Further, it is preferable that the processing apparatus 50 be capable of controlling temperatures from a room temperature to 60° C., and own an atmospheric circulating function. The transporting means 51 is typically known as a conveyer, and preferably, the transporting speed of the transporting means 51 may be changed in response to processing speeds of 0.1 to 1.5 m/min.

As an experimental example, a spray amount of the process fluid is set to 10 ml/min, a processing speed of the transporting means 51 is set to 0.10 m/min, and a temperature in the chamber 52 is set to 30 degrees Celsius. Under condition mentioned above, the liquid crystal display apparatus 55 under semi-finished condition is mounted on the transporting means 51. Next, the liquid crystal display apparatus 55 under the semi-finished condition is conveyed into the chamber 52. It should also be noted that the temperature in the chamber 52 is controlled, and the atmosphere in this chamber 52 is set in such a manner that the process fluid is circulated in the mist form. As a result, the mists are adsorbed on the surface of the liquid crystal display apparatus 55 (to be specific, upper polarizing film 13) under semi-finished condition. As a consequence, particles of the process fluid, the dimensions of which are several tens of μm, express an affinity for the processing plane. As a result, such a uniform antistatic membrane 41 having a thickness equal to or smaller than approximately 1 μm is formed. Finally, the liquid crystal display apparatus 55 under the semi-finished condition, on which the antistatic membrane 41 is formed, is carried out from the chamber 52.

Thereafter, the touch panel 20A is mounted on the liquid crystal display apparatus 55 under the semi-finished condition, on which the antistatic membrane 41 has been formed. Then, the liquid crystal display apparatus 100 with the touch panel 20A mounted thereon is completed. The touch panel 20A has been fixed on the chassis frame 30 through the two-sided adhesive compound 32.

As a method for electrically opening the antistatic layer 41, a portion other than the surface of the upper polarizing film 13 may be masked. Alternatively, after the mist-formed surface active agent has been adsorbed, the antistatic membrane 41 formed on the portion other than the surface of the upper polarizing film 13 may be removed.

Measurement results of the liquid crystal display apparatus 100 with the touch panel 20A mounted thereon, according to Exemplary Aspect 1, are described as follows. FIG. 3 is a graph for representing a relationship between contact numbers and charged amounts of liquid crystal panels and touch panels. It should be noted that a sample B shows the liquid crystal display apparatus 100 having the antistatic membrane 41 according to Exemplary Aspect 1, and a sample A represents the conventional liquid crystal display apparatus which has no such an antistatic membrane. In the conventional liquid crystal display apparatus (i.e., sample A), a charged amount is increased in directly proportional to a contact number. In contrast, in the liquid crystal display apparatus 100 (i.e., sample B) according to Exemplary Aspect 1, even when a contact number is increased, there is no change in a charged amount at all.

Next, FIG. 4 shows a relationship between contact numbers and sound levels between liquid crystal panels and touch panels. It should also be noted that the sample B shows the liquid crystal display apparatus 100 having the antistatic membrane 41 according to Exemplary Aspect 1, and the sample A represents the conventional liquid crystal display apparatus which has no such an antistatic membrane. In the conventional liquid crystal display apparatus (i.e., sample A), a sound level is increased in directly proportional to a contact number. In contrast, in the liquid crystal display apparatus 100 (i.e., sample B) according to Exemplary Aspect 1, even when a contact number is increased, there is no change in a sound level at all.

Effects of the liquid crystal display apparatus 100 with the touch panel 20A mounted thereon according to Exemplary Aspect 1 will now be described. As previously explained, in the liquid crystal display apparatus 100 with the touch panel 20A mounted thereon, the antistatic membrane 41 has been formed on the surface of the upper polarizing film 13 on the display plane side of the liquid crystal panel 10A under electrically open condition.

This structure produces a first effect of Exemplary Aspect 1 that it is possible to suppress that the electric charges produced by the static electricity are charged to the peeled part in a concentrative manner. This is because it is suppressed that the static electricity is concentrated to the peeled part in the case where the liquid crystal panel 10A and the touch panel 20A are contacted to each other and come off each other within the air layer 40.

A second effect of Exemplary Aspect 1 is achieved by that the generation of the sound can be suppressed. This is because in Exemplary Aspect 1, since the concentrative electric charges are suppressed, the vibrations are not amplified which are synchronized with the amplitudes of the common electrode signal.

A third effect of Exemplary Aspect 1 is achieved by that the thickness of the air layer 40 can be made thin. This is because in Exemplary Aspect 1, even if the liquid crystal display panel 10A and the touch panel 20A are contacted to each other and come off each other within the air layer 40, the concentrative electric charges, the vibrations, and the sound can be hardly produced.

A fourth effect of Exemplary Aspect 1 is achieved by the thickness of the touch panel 20A can be made thin. This is because in Exemplary Aspect 1, since the concentrative electric charges, the vibrations, and the sound can be hardly produced, there is no necessity that the thicknesses of the structural elements are made thick.

As a result of these effects, a fifth effect of Exemplary Aspect 1 is achieved by that the entire thickness of the liquid crystal display apparatus 100 can be made thin.

Further, when the protection layer is provided, a sixth effect of Exemplary Aspect 1 is achieved by that it is possible to avoid that a failure such as a scratch is made on a surface layer of the antistatic membrane 41 in the assembling stage and the examining stage.

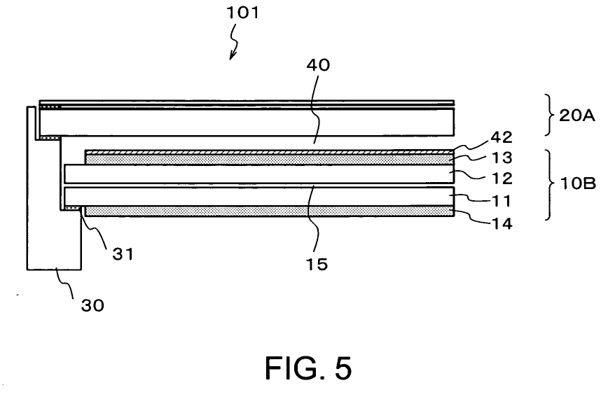

Next, a liquid crystal display apparatus 101 equipped with a touch panel 20A and a manufacturing method thereof according to Exemplary Aspect 2 of the present invention will now be described with reference to FIG. 5. FIG. 5 is a side view for schematically indicating a structure of the liquid crystal display apparatus 101 equipped with the touch panel 20A, according to Exemplary Aspect 2 of the present invention.

The liquid crystal display apparatus 101 of Exemplary Aspect 2 includes a liquid crystal panel 10B, the touch panel 20A, and a chassis frame 30 which holds the liquid crystal panel 10B and touch panel 20A. The liquid crystal panel 10B includes a TFT substrate 11, a color filter substrate 12, a liquid crystal layer 15, polarizing films 13 and 14, and a conductive membrane 42. It should also be noted that the same reference numerals shown in Exemplary Aspect 1 will be employed as those for denoting the same or similar structural components, and explanations thereof are omitted.

In Exemplary Aspect 1 described above, after the liquid crystal panel 10A is fixed on the chassis frame 30, the antistatic membrane 41 is formed on the surface of the upper polarizing film 13 arranged on the display plane side of the liquid crystal panel 10A.

On the other hand, in Exemplary Aspect 2, before the liquid crystal panel 10B is fixed on the chassis frame 30, a conductive layer 42 is formed on the surface of the upper polarizing film 13 arranged on the display plane side of the liquid crystal panel 10B. It should be noted that this conductive layer 42 is assembled in the liquid crystal display apparatus 101 with the touch panel 20A mounted thereon under electrically open status. To be specific, in FIG. 5, the conductive layer 42 is formed on the uppermost plane of the upper polarizing film 13 arranged on the display plane side of the liquid crystal panel 10B by a coating method, a vapor deposition method, a sputtering method, a printing method, or the like.

It should be noted that the conductive layer 42 may merely have an electric conductive characteristic. Also, it is preferable that this conductive layer 42 be made of a material and a thickness capable of obtaining a sufficiently high transmittance. For instance, it is desirable that a surface resistance value of the conductive layer 42 be equal to or lower than an approximately 1×E12 Ω/square. As a result, the concentrative charging operations can be more effectively prevented. Also, it is preferable that the conductive layer 42 be made of a colorless and transparent layer, and a visible light transmittance thereof is equal to or higher than approximately 95%. As a result, it is possible to avoid that a display is disturbed. Also, a thickness of the conductive layer 42 may be made equal to or smaller than approximately 1 μm. The conductive layer 42 may be formed by such a transparent conductive membrane containing, for example, a metal oxide such as an indium oxide as a main component, or may be made of a membrane which contains conductive metal-based particles such as aluminum and chromium. These materials have effects capable of conducting electrons (i.e., ions).

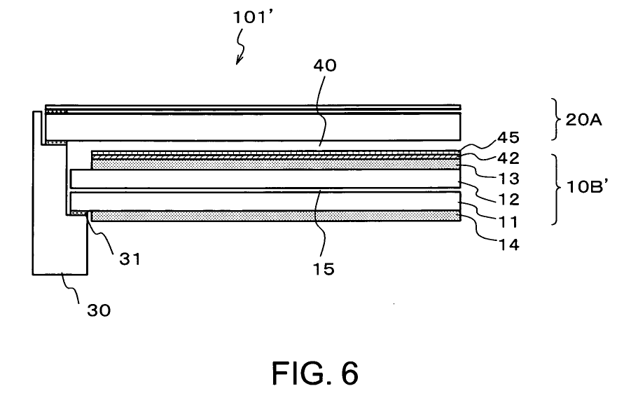

Also, in the subsequent assembling stage and the like, if there is a certain possibility that a failure such as a scratch is made on a surface layer of the conductive layer 42, then a protection layer 45 may be alternatively provided on the surface side of the conductive layer 42 as indicated in FIG. 6. As a consequence, the protection layer 45 protects the conductive layer 42 from the failure such as the scratch which lowers the conductive performance. It should also be noted that the protection layer 45 may be preferably made of such a material which can hardly deteriorate the conductive performance. As examples, acrylic-based materials, Teflon-based materials, and the like may be applied. Even under such a condition that the protection layer 45 is provided, an increased thickness may be reduced equal to or smaller than approximately 50 μm.

Instead of such a structure that the conductive layer 42 is formed by a sputtering method or the like, a film having a similar function may be alternatively adhered onto the surface of the upper polarizing film 13. Even in such an alternative case, an increased amount of the entire thickness of the liquid crystal panel 10A may be reduced equal to or smaller than 5%.

As previously explained, in the liquid crystal display apparatus 101 equipped with the touch panel 20A, according to Exemplary Aspect 2, the conductive layer 42 has been formed on the surface of the upper polarizing film 13 on the display plane side of the liquid crystal panel 10B under electrically open condition. With employment of this structure, similar to Exemplary Aspect 1, it is possible to suppress that the electric charges produced by the static electricity are charged to the peeled part in a concentrative manner, while the static electricity is generated, in the case where the liquid crystal panel 10B and the touch panel 20A are contacted to each other and come off each other within the air layer 40. Accordingly, Exemplary Aspect 2 has a similar effect to that of Exemplary Aspect 1. To be specific, also in Exemplary Aspect 2, as a first effect, concentrative charging operations can be suppressed. As a result of this first effect, the sound production can be suppressed as a second effect. Also, as a result of these effects, the thicknesses of the air layer 41, the touch panel 20A, and the entire thickness of the liquid crystal display apparatus 101 can be made thin, as third, fourth, and fifth effects. Further, as a sixth effect, in the case where the protection layer 45 is provided, it is possible to avoid that the failure such as the scratch is made on the surface layer of the conductive layer 45 in the assembling stage, the examining stage, and the like.

In addition to these effects, in Exemplary Aspect 2, since the conductive layer 42 is previously provided on the upper polarizing film 13, there is another effect that the subsequent assembling stages can be simplified. Also, Exemplary Aspect 2 may own another effect that in the manufacturing stage of the upper polarizing plate 13, the conductive layer 42 may be formed by a relatively simple method such as a coating method and a printing method.

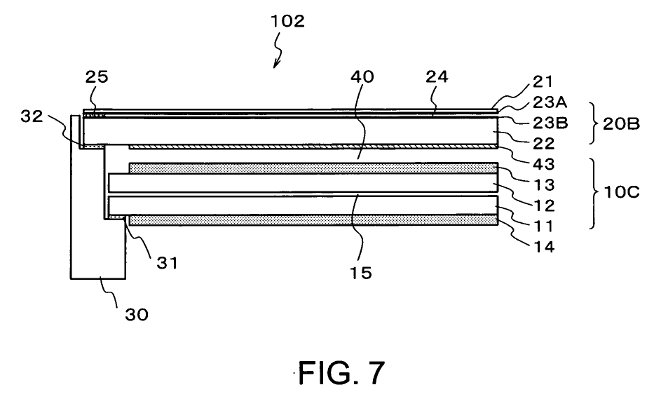

Next, a liquid crystal display apparatus 102 equipped with a touch panel 20B, and a manufacturing method thereof, according to Exemplary Aspect 3 of the present invention will now be described with reference to FIG. 7. FIG. 7 is a side view for schematically indicating a structure of the liquid crystal display apparatus 102 equipped with the touch panel 20B, according to Exemplary Aspect 3 of the present invention.

The liquid crystal display apparatus 102 of Exemplary Aspect 3 includes a liquid crystal panel 10C, the touch panel 20B, and a chassis frame 30 which holds these liquid crystal panel 10C and touch panel 20B. The liquid crystal panel 10C includes a TFT substrate 11, a color filter substrate 12, a liquid crystal layer 15, and polarizing films 13 and 14. Also, the touch panel 20B includes an upper substrate 21, a lower substrate 22, transparent conductive membranes 23A and 23B, and a conductive layer 43. It should also be noted that the same reference numerals shown in Exemplary Aspect 1 will be employed as those for denoting the same or similar structural components, and explanations thereof are omitted.

In Exemplary Aspects 1 and 2 described above, either the antistatic membrane 41 or the conductive layer 42 has been formed on the side of either the liquid crystal panel 10A or the liquid crystal panel 10B. On the other hand, in Exemplary Aspect 3, the conductive layer 43 has been formed on the side of the touch panel 20B. It should be noted that this conductive layer 43 is assembled in the liquid crystal display apparatus 102 with the touch panel 20B mounted thereon under electrically open status. To be specific, in FIG. 7, the conductive layer 43 is formed on a lower plane of the lower substrate 22 of the touch panel 20B by a coating method, a vapor deposition method, a sputtering method, a printing method, or the like.

It should also be understood that this conductive layer 43 owns a similar characteristic and a similar feature to those of Exemplary Aspect 2. The conductive layer 43 may be made of a material equivalent to that of Exemplary Aspect 2. Also, a protection layer may be alternatively provided on the surface side of the conductive layer 43 in order to protect the conductive layer 43 from a failure such as a scratch. Even when the protection layer is provided, an increased amount of the entire thickness of the touch panel 20B may be suppressed equal to or smaller than 5%.

Also, similar to Exemplary Aspect 2, instead of the conductive layer 43, a film having a similar effect may be adhered to the lower substrate 22. Instead of the conductive layer 43, an antistatic membrane similar to that of Exemplary Aspect 1 may be alternatively formed on the lower plane of the lower substrate 22.

As previously explained, in the liquid crystal display apparatus 102 with the touch panel 20B mounted thereon, according to Exemplary Aspect 3, the conductive layer 43 is previously formed on the surface of the lower substrate 22 which constitutes the touch panel 20B under electrically open condition. With employment of this structure, similar to Exemplary Aspects 1 and 2, it is possible to suppress that the electric charges produced by the static electricity are charged to the peeled part in a concentrative manner, while the static electricity is generated, in the case where the liquid crystal panel 10C and the touch panel 20B are contacted to each other and come off each other within the air layer 40. Accordingly, Exemplary Aspect 3 has a similar effect to that of Exemplary Aspect 1. Also, since the conductive layer 43 is previously provided on the lower substrate 22, Exemplary Aspect 3 owns a similar effect to that of Exemplary Aspect 2.

The structural examples of the display apparatus according to the present invention have been described. However, the shapes and the arrangements of the respective structural components, and the fixing structures are not limited only to those shown in these drawings, but may be properly modified without departing from the technical scope reflecting the features of the present invention. Also, the driving method of the display apparatus may be properly changed without departing from the technical scope reflecting the feature of the present invention.

In Exemplary Aspects 1 and 2, either the antistatic membrane 41 or the conductive layer 42 is formed on the liquid crystal panel 10A side, whereas in Exemplary Aspect 3, the conductive layer 43 is formed on the touch panel 20B side. However, either Exemplary Aspect 1 or Exemplary Aspect 2 may be combined with Exemplary Aspect 3, so that either the antistatic membrane or the conductive layer may be formed on both the liquid crystal panel and the touch panel. As a result, it is possible to more strongly suppress that electric charges are concentrated to the peeled part.

In the above-explained structural examples from Exemplary Aspects 1 to 3, the application examples to TFT type liquid crystal display apparatus have been described. However, the present invention may be applied to other liquid crystal display apparatus than the TFT type display apparatus such as an super twisted nematic (STN) type liquid crystal display apparatus. Further, the present invention may be applied to other panel type display apparatus than the TFT type display apparatus such as a plasma display apparatus and an organic electro-luminescence (EL) display apparatus.

Further, the present invention may be alternatively applied not only to a display apparatus with a touch panel mounted thereon, but also to a display apparatus with a cover panel mounted thereon, or various sorts of electronic devices equipped with display apparatus. For instance, the present invention may be applied to such a display apparatus that a cover panel for protecting a display unit is mounted on the display plane side of a display panel. As a result, even in such a case where the cover panel is contacted to and peeled from the display panel, it is possible to avoid that the electric charges are concentrated to the peeled part.

As specific application examples of the present invention, there are portable terminals, mobile terminals, and input/output and display apparatus of various sorts of electronic devices. As specific examples of the portable terminals, there are a portable telephone, a Smartphone, a PDA, a tablet computer, a mobile computer, a notebook personal computer, a game machine, an electronic dictionary, and a digital camera. As specific examples of the mobile terminals, there are a car navigation device and a car audio device. As specific examples of the input/output and display apparatus of various sorts of devices, there are an automated teller machine (ATM) and a manufacturing apparatus.

While the present invention has been described in connection with certain exemplary embodiments, it is to be understood that the subject matter encompassed by way of the present invention is not to be limited to those specific embodiments. On the contrary, it is intended for the subject matter of the invention to include all alternatives, modifications and equivalents as can be included within the spirit and scope of the following claims.

Further, the inventor's intent is to retain all equivalents of the claimed invention even if the claims are amended during prosecution.

1. A display apparatus, comprising:
a display panel displaying an image thereon;
a cover panel arranged facing the display panel across an air layer; and
an electro-conductive material opening electrically and arranged on a surface of one of the display panel and the cover panel faced with the air layer.

2. A display apparatus according to claim 1, wherein the cover panel comprises a touch panel for detecting a pressed position.

3. A display apparatus according to claim 1, wherein the electro-conductive material comprises one of an antistatic membrane and a conductive layer.

4. A display apparatus according to claim 1, wherein a surface resistance value of the electro-conductive material is equal to or lower than 1×E12 Ω/square.

5. A display apparatus according to claim 1, wherein a visible light transmittance of the electro-conductive material is equal to or higher than 95%.

6. A display apparatus according to claim 1, wherein a thickness of the electro-conductive material is equal to or smaller than 1 micron.

7. A display apparatus according to claim 1, wherein the electro-conductive material contains a nonionic-based surface active agent.

8. A display apparatus according to claim 1, wherein the electro-conductive material contains a metal oxide.

9. A display apparatus according to claim 8, wherein the metal oxide contains one of an indium oxide and a tin oxide.

10. A display apparatus according to claim 1, wherein the electro-conductive material contains a metal.

11. A display apparatus according to claim 1, further comprising:
a protection film for protecting the electro-conductive material on the surface of the electro-conductive material.

12. A display apparatus according to claim 1, wherein the display apparatus comprises a liquid crystal display apparatus.

13. An electronic device equipped with a display apparatus, comprising the display apparatus according to claim 1.

14. A method of manufacturing a display apparatus comprising a display panel for displaying an image thereon, the method comprising:
forming a nonionic-based surface active agent in a mist form;
causing the nonionic-based surface active agent to be adsorbed on a surface of the display panel; and
forming an electrically opened electro-conductive material on the surface of the display panel.

15. A method of manufacturing a display apparatus according to claim 14, further comprising:
arranging a cover panel to face the display panel across an air layer.

16. A method of manufacturing a display apparatus according to claim 15, further comprising:
providing the cover panel with a touch panel for detecting a pressed position.

17. A method of manufacturing a display apparatus according to claim 14, further comprising:
containing a fluorine-based surface active agent in the nonionic-based surface active agent.

18. A method of manufacturing a display apparatus according to claim 14, further comprising:
setting a surface resistance value of the electro-conductive material to be equal to or lower than 1×E12 Ω/square.

19. A method of manufacturing a display apparatus according to claim 14, further comprising:
setting a visible light transmittance of the electro-conductive material to be equal to or higher than 95%.

20. A method of manufacturing a display apparatus according to claim 14, further comprising:
setting a thickness of the electro-conductive material to be equal to or smaller than 1 micron.
